(19) United States
(12) Patent Application Publication
(10) Pub. No.: US 2002/0167887 A1
(43) Pub. Date: Nov. 14, 2002

(54) Near-field crystal optical memory

(76) Inventor: Marko Moscovitch, Potomac, MD (US)

Correspondence Address: RENNER, OTTO, BOISSELLE & SKLAR, LLP, Nineteenth Floor, 1621 Euclid Avenue, Cleveland, OH, 44115-2191, US

(21) Appl. No.: 10/143,497

(22) Filed: May 10, 2002

Related U.S. Application Data
(63) Continuation of application No. PCT/US00/30802, filed on Nov. 10, 2000.
(60) Provisional application No. 60/164,574, filed on Nov. 10, 1999.

(51) Int. Cl. G11B 7/00

(52) U.S. Cl. 369/121; 369/126; 369/112.23; 369/59.24; 369/112.27

(57) ABSTRACT

An optical data storage system, particularly suited for use in the information and entertainment industries. A near-field crystal optical memory (NCOM) system includes an electron trapping media, particularly an α-Al₂O₃:C crystal or Cu⁺-doped fused quartz, that is sensitive to light. Information is stored and retrieved using blue and green laser light, respectively. High data density is achieved using a near-field scanning optical microscopy (NSOM) technique, by placing the optical probe in a very close proximity to the crystal surface. The storage system enables ultra-high data densities reaching 2500 Gb/in².

### RELATED APPLICATION DATA

This application is a continuation of International Patent Application No. PCT/US00/30802 filed Nov. 10, 2000, which claims the benefit of Provisional Application No. 60/164,574 filed Nov. 10, 1999, both of which are hereby incorporated herein by reference in their entireties.

### FIELD OF THE INVENTION

The invention herein described relates to an optical data storage system, particularly suited for use in the information and entertainment industries.

### BACKGROUND

There is a variety of data storage technologies currently on the market. These include read only devices such as CD-ROM and laser disks, write once read many disks (WORM), re-writable magneto-optic disks (MO) and digital versatile disk (DVD). DVDs are considered to be the most advanced optical disks commercially available (see Halfhill T. R., “CDs for the gigabyte era”, Byte, 21,139-144 (October 1996)). They have the same physical size as standard compact disk (CD), but are capable to store 4.7 to 17 GB per disk, depending on the format. The capacity of a DVD can be up to 25 times higher than a CD that can store only approximately 0.7 GB. The data rate of DVD-ROM is 1.4 MB/s as compared to 0.15 Mb/s for a CD-ROM (x1). In both CD and DVD the data is stored in the form of microscopic pits representing binary digits (0 or 1). The higher capacity of DVD is achieved by combining five different techniques: (1) reducing the size of a pit from 0.8 to 0.4 μm, which enables a higher pit density (2) decreasing the distance between tracks from 1.6 to 0.7 μm, (3) decreasing the wavelength of the laser from 780 nm to 650 nm, (4) storing data on both sides of the disk, and (5) the use of dual layering, i.e. each side has a “sandwich” of two data recording layers, where the button layer is fully reflective and the top layer is semi-transparent. DVD is currently only a read only device (like CD-ROM). There are expectations that write-once and re-writable DVD for data storage applications will become available in the near future. It is unlikely however that recordable DVD video will appear soon on the market. This is because fitting two hours of video on a DVD requires real-time compression which can be quite expensive and complicated.

Existing data storage technologies are not capable of meeting the demand for high-speed high-density data storage and retrieval devices. This particularly applies to “data hungry” applications such as multimedia, internet, virtual reality, data bases, etc. The amount of data storage capacity required for these applications is quickly increasing due to the extensive use of realistic graphics, video, and sound. A growing number of companies are creating and distributing information databases in electronic form and there is a need to store all the information on a single disk, rather than on multi-volume CD sets. The use of a single disk will eliminate the need for the cumbersome disk-swapping that even with automatic CD changers is still slow. The entertainment industries such as Hollywood and music recording companies will also benefit from a ultrahigh density data storage device. Such a device could replace VHS video cassettes, and enable the storage of many movies on a single disk. Higher data density will result in higher quality of video and sound, and will enable the use of multiple-language soundtracks. In short, there is a real need for a new storage technology to meet current and future information storage requirements.

### SUMMARY OF THE INVENTION

The present invention provides an optical data storage system and method, particularly suited for use in the information and entertainment industries. The optical data storage system and method are characterized by the use of an optical memory element in which information is written and read using different light frequencies. In a preferred embodiment of the invention, the recording medium is an electron trapping material, for example, an α-Al₂O₃:C crystal or Cu⁺-doped fused quartz, that is sensitive to light, and high data density is achieved using a near-field scanning optical microscopy (NSOM) technique, by placing the optical probe in a very close proximity to the crystal surface. The storage system enables ultra-high data densities reaching 2500 Gb/in².

According to one aspect of the invention, an optical data storage system comprises a storage medium in which information is written and read using different light frequencies. In a preferred embodiment, the storage medium includes an electron trapping phosphor-based compound and a near-field scanning optical microscopy (NSOM) device is used for reading and/or writing to the storage medium.

According to another aspect of the invention, an optical data storage method comprises the steps of using a light frequency of a first wavelength to write information in an optical storage medium, and using a light frequency of a different wavelength to read the written information. In a preferred embodiment, the storage medium includes an electron trapping phosphor-based compound and a near-field scanning optical microscopy (NSOM) device is used to read and/or write to the storage medium.

The foregoing and other features of the invention are more particularly described hereinafter.

### BRIEF DESCRIPTION OF THE DRAWINGS

FIG. 1 is an illustration of an information storage and retrieval cycle according to the invention.

FIG. 2 shows the relationship between the surface of a recording medium and the tapered tip of an optical fiber used in a near-field optics system according to the invention.

FIG. 3 illustrates a comparison between a six-level data storage format and a two level data storage format.

FIG. 4 shows the sensitivity of α-Al₂O₃:C to different colors of light.

FIG. 5 shows the optical stimulation luminescence spectrum for α-Al₂O₃:C.

FIG. 6 is an illustration of multi-level data recording in α-Al₂O₃:C using different intensities of blue light.

FIG. 7 is a schematic illustration of a near-field scanning optical microscopy system.

### DESCRIPTION OF THE INVENTION

The invention provides an optical data storage system, particularly suited for use in the information and entertainment industries. A near-field crystal optical memory (NCOM) system includes a small light sensitive crystal disk, where information is stored and retrieved using a microscopic scanning optical probe preferably placed in a very close proximity to the crystal surface. The system enables unmatched performance and functionality of a data storage media.

An embodiment of NCOM system is based on quantum effects in light-sensitive α-Al₂O₃:C crystals. Information is “written” on the crystal using blue laser light focused to a spot of approximately 50 nm through a small aperture. The blue light removes individual electrons from their atoms and raises them to an elevated energy level where they are trapped. The information is “read” using green laser light which releases some of the trapped electrons which drop to a lower energy level and emit light in the process. Since this process does not use thermal effects (as do conventional memories such as CD-ROM, DVD and magneto-optic disks), the reading and writing processes are much faster and require lower power lasers. Furthermore, since the effect is reversible, there is no practical limit to the number of times the information can be written or read. The α-Al₂O₃:C medium has a nearly linear response, enabling multi-level data storage format. This format can increase the information density by many times as compared to the conventional binary format and this makes possible commercial systems that can store up to 2500 GB per square inch. This corresponds to approximately 350 hours of minimally compressed video.

One preferred optical recording media is an aluminum-oxide crystal doped with carbon impurities. Some of the anion lattice sites are vacancies (“anion-defective”). These vacancies are responsible for the high sensitivity of the material to light, and enable it to be used as a data storage media. This special form of aluminum-oxide is called α-Al₂O₃:C, and is available commercially from two sources: (1) Bicron-NE, Cleveland, Ohio, and (2) Stillwater Technologies, Stillwater, Okla. The material is currently used for ionizing radiation detection and is manufactured in the form of small disks, although any shape and size can be easily produced. Applicant has discovered that α-Al₂O₃:C is sensitive to blue light and can be used as the basis of data storage system.

Another preferred optical recording media is Cu⁺-doped fused quartz which is sensitive to infrared light. Cu⁺-doped fused quartz can be fabricated using a low cost, semiconductor grade, clear fused quartz glass. The fused quartz has high optical transmission throughout the ultraviolet, visible and infrared wavelength regions (˜250 nm to ˜4000 nm). Cu⁺ ions can be introduced into the fused quartz by thermal diffusion. Further details of such material can be found in B. L. Justus et al, “Optically and Thermally Stimulated Luminescence Characteristics of Cu⁺-Doped Fused Quartz”, Rad. Prot. Dosim., 81, pp. 5-10 (1999), which is hereby incorporated herein in its entirety.

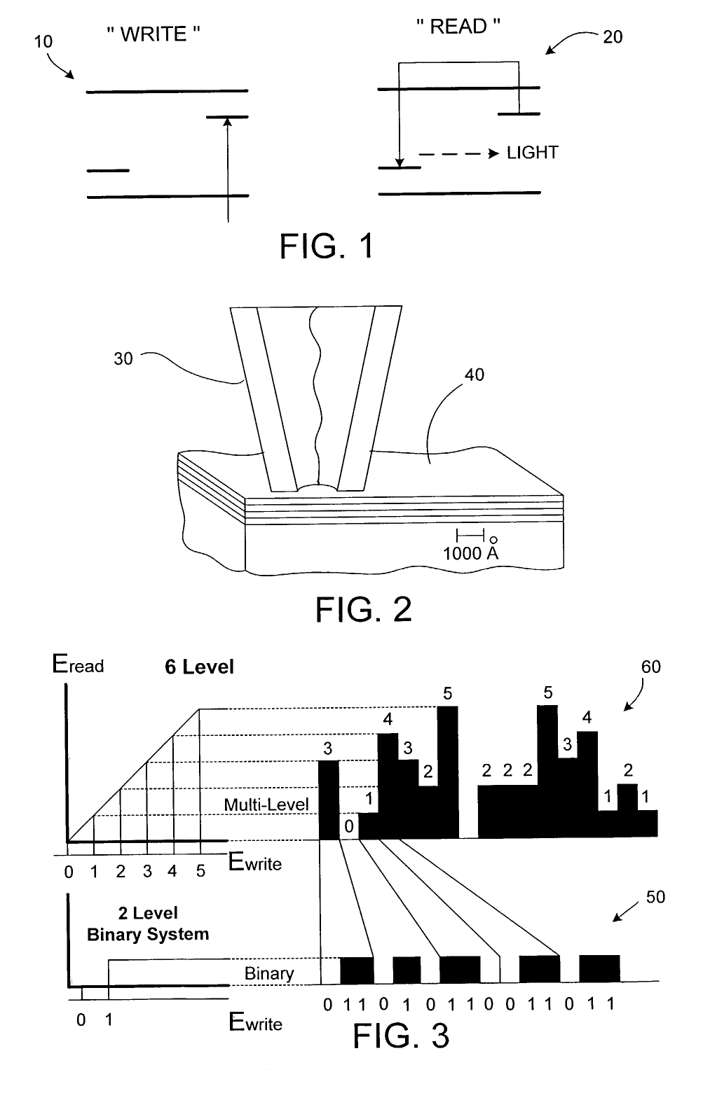

The data storage and retrieval in α-Al₂O₃:C crystals or Cu⁺-doped fused quartz is based on the quantum process known as optically stimulated luminescence (OSL), illustrated schematically in FIG. 1. For a discussion of optically stimulated luminescence, reference may be had to Botter-Jensen L., and McKeever S. W. S., “Optically stimulated luminescence dosimetry using natural and synthetic materials”, Rad. Prot. Dosim., 65, 273-280 (1996), which is hereby incorporated herein by reference in its entirety. Light is used to transfer electrons between different energy levels in the crystal. When the crystal is exposed to blue light, electrons are removed from their atoms and transferred to higher energy levels where they are trapped as depicted at 10 in FIG. 1. The “written” data is represented by energy stored in the material in the form of these trapped electrons. The electrons remain trapped for unlimited period of time until the crystal is stimulated or “read” with green light. The green light transfers the electrons from the high energy traps to a lower energy level as depicted at 20 in FIG. 1. The excess energy is released in the form of visible light that can be detected and used as a measure of the written information.

The “read” process is destructive, i.e. the data is erased upon readout. This is not the only material that the data is erased in the readout process, and even conventional silicon RAM (random access memories) used in personal computers have short storage time and must be refreshed continuously. To solve this problem, a refresh cycle is used, whereby the read operation will be followed immediately by a refresh cycle which rewrites the data to the same location. This is transparent to the system and the user.

To achieve ultra-high density of data storage, near-field optics technology is used in the system. As with conventional optical data storage devices, the near field system uses laser light to read and write data. However, rather than using lens to focus the laser beam on the recording medium, the light is directed into a probe made from aluminum-coated optical fiber, tapered to a tiny point at the end as illustrated in FIG. 2. In FIG. 2, the tapered tip 30 of the optical fiber is shown in shown in relation to the recording medium 40.

The diameter of the light beam at the end of the fiber is approximately 50 nm (this is approximately 1000 times smaller than the diameter of a human hair). When the tip 30 is placed near the surface of the recording crystal 40 it produces a 60 nm light spot. This is much better than the resolution in conventional, lens-based systems, that are limited by the “diffraction limit” where the light spot size can't be smaller than the wavelength of the light (1000 nm). The distance between the probe and the surface of the crystal can be controlled to be constantly about 30 nm above the surface of the crystal. This is done by detecting the shear force of the probe, received from the surface of the crystal. Hitachi demonstrated the possibility of achieving recording density of 170 Gb/in² and readout speeds over 10 Mb/s using binary recording. See Hosaka S., Shintani T., Miyamoto M., Kikukawa A., Yoshida M., Fujita K. and Kammer K., “Phase change recording using a scanning near-field optical microscope”, J. Appl. Phys., 79, 8082-8086(1996), which is incorporated herein by reference in its entirety.

The system of the present invention preferably uses multi-level data storage. Multi-level storage increases the storage capacity by at least a factor of 15 as compared to two-level (binary) recording. A system according to the present invention will be able to achieve a storage capacity of approximately 2500 Gb/in². This is equivalent to storing 250 DVDs on an inch-squared. Data rates of at least 10 MB/s are attainable, which is approximately six time faster than the data rate of the new DVD which is only 1.4 MB/s.

As above indicated, the system uses near-field optics for data recording in the light sensitive crystals. For details, reference may be had to Hess H. F., Betzig E., Harris T. D., Pfeiffer L. N., and West K. W., “Near-field spectroscopy of the quantum constituents of a luminescent system”, Science 264, 1740-1745(1994), which is hereby incorporated herein by reference. Two types of near-field scanning microscopy systems are available commercially from TopoMetrix, Santa-Clara, Calif. A system suitable for the read/write mechanism is the “Aurora” near-field scanning optical microscopy system available from TopoMetrix, Santa Clara, Calif.

It is noted that slow initial positioning of a conventional probe may be avoided by ultra-fine polishing of the surface of the crystal to reduce topographical variations to 25 nm or less. This may eliminate the need for repositioning of the probe in the z-direction (normal to the surface) and thus only x-y (or radial) positioning would be necessary. During data writing, reading, or re-positioning, the spacing between the probe tip and the crystal surface pre-value held and controlled by shear-force feedback.

Assuming that there is no need for repositioning along the z-axis, the access time, Ta, is given by Ta=Ts+Tl, where Ts is the time needed for the tip to get to a target track and Tl is the time spent on the target track while waiting for the desired sector. The value of Ts is dependent on the radius of the disk. Seek times for the read/write head are expected in the range of 20-40 ms. A randomly selected sector will be on the average halfway along the track from the point where the tip initially lands. Thus, for a disk rotating at 3600 rpm, Tl is approximately 8 ms. One can therefore expect re-positioning or access time on the order of 30-50 ms, similar to existing optical drives. Making use of at least 10 levels of multi-level data storage as discussed herein, on average there will be 10 times less jumps as compared to typical optical drives, and as a result, effective access time is expected to be in the range of 3-5 ms.

Multi level data storage format (developed by Optex Co.) enables significant increase in data density and rate. In conventional storage technologies data is stored in a binary (two level) format, 1 or 0, where 1 means the existence of a certain effect (such as a hole burned in a laser disk), and 0 means the absence of the same effect. Multi-level data storage format is not limited to only two levels, and can reach as many levels as the properties of the recording medium permit. The sensitivity of α-Al₂O₃:C to light is an increasing function of the light intensity. As a result, this recording medium is capable of storing multi-levels of data. More bits are stored and retrieved simultaneously from the same location where conventional systems store only one bit. This provides an increase in recording density and data rate as compared to a binary system. For example, as shown in FIG. 3, binary (011) occupies three physical locations on a binary system as seen at 50, and only one location on a multilevel system as seen at 60. Multi-level data storage is different than the approach under development by IBM that is based on the use of multiple-physical-layers of magneto-optic recording media. The IBM system is still binary in nature and although the data capacity is increased by increasing the number of layers, the data density remains low. The data rate in the IBM system is also expected to remain low because each layer is addressed separately. The novel application of multi-level format to near-field data storage provides for an increase in data storage capacity by almost three orders of magnitude as compared to traditional methods.

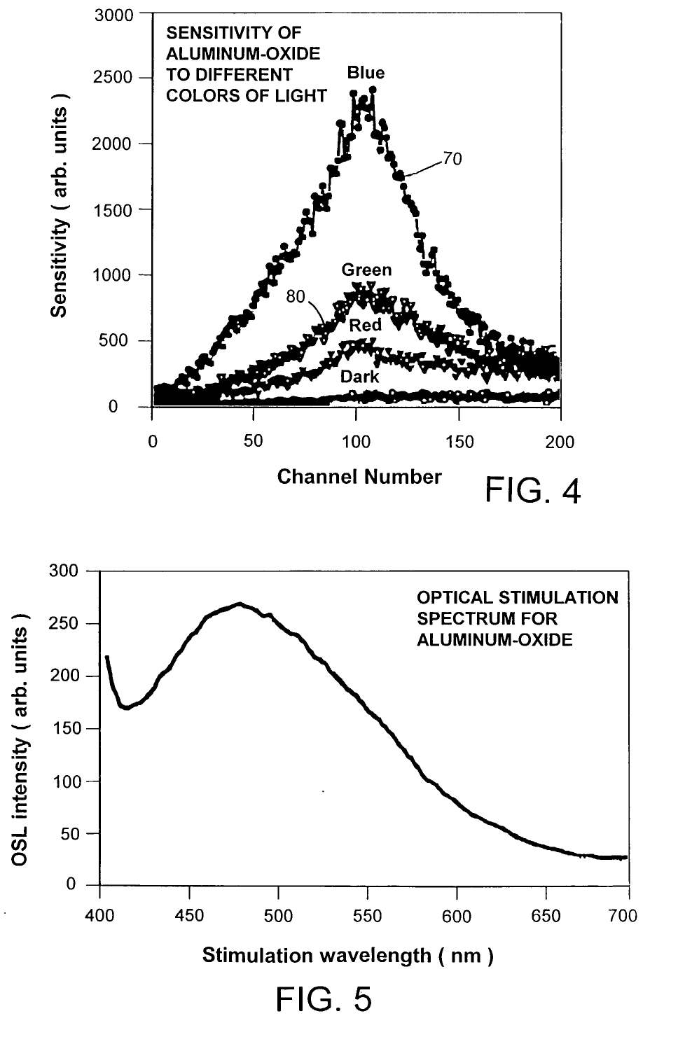

It has been demonstrated by the inventor that visible light can be used for writing and reading information on α-Al₂O₃:C disks. In addition, it has been shown by the inventor that this crystal is capable of multi-level data storage. Measurements were taken by exposing single crystals of α-Al₂O₃:C to different colors of incandescent light. Information is written when the light populates high energy levels in the crystal (see FIG. 1). To determine the relative numbers of electrons that were trapped in these high energy levels, the samples were heated up to 280° C. Upon heating, the trapped electrons are released and then re-trapped in lower energy levels, followed by emission of photons. This light was measured using a photomultiplier tube. As shown in FIG. 4, the material is significantly more sensitive to blue light (line 70) as compared to green light (line 80). It demonstrated therefore that it is possible to write information by using blue light to excite electrons to meta-stable high energy levels. To read the information, the crystal is exposed to green light that provides optical stimulation to transfer trapped electrons to lower energy levels, followed by photon emission (similar to the effect of heat). This phenomena is known as optical stimulation luminescence (OSL), and the OSL spectrum for α-Al₂O₃:C³ is shown in FIG. 5. As shown in FIG. 5, the OSL sensitivity is the highest for green light. In short, the “write” sensitivity is high for blue light and low for green light, and the “read” sensitivity is high for green light and low for blue light. It is possible therefore to distinguish between the “write” and the “read” operations, by simply using different colors of light (blue for “write” and green for “read”).

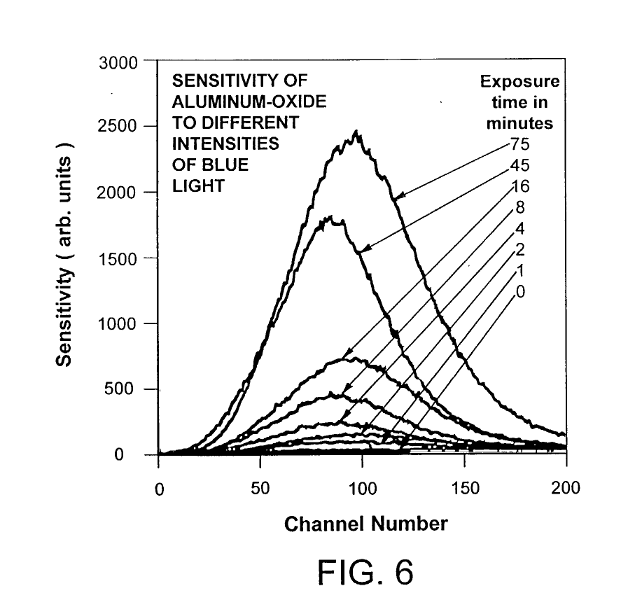

To demonstrate the feasibility of data recording using multi-level format, the intensity of the blue “write” beam was increased by changing the exposure time. As shown in FIG. 6, the sensitivity is an increasing function of the light intensity. Since a low power incandescent light was used in the experiment, the exposure times were long. In the actual data recording application, the light source will be a focused laser, producing the same effect in a fraction of a microsecond. FIG. 6 shows 8 levels, although the maximum number of levels is not known yet, and will be determine by the saturation level of the crystal.

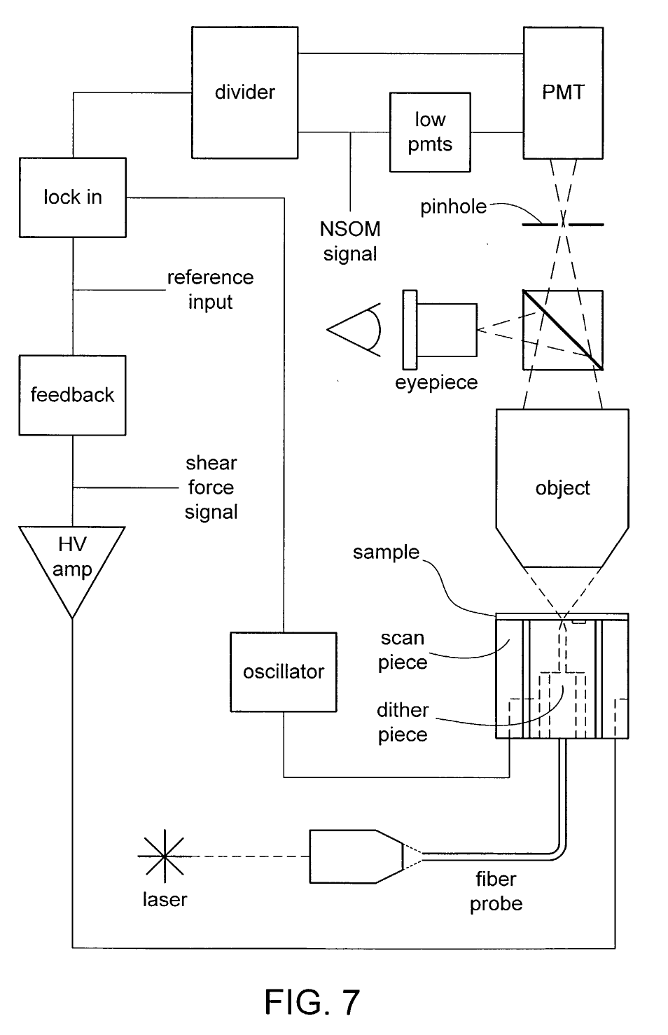

A practical system will permit data storage and retrieval using α-Al₂O₃:C or Cu⁺-doped fused quartz discs as the recording media. It will also enable binary as well as multi-level data formats. System components include, for example, the Aurora NSOM (Betzig E., Finn P. L., and Weiner J. S., “Combined shear force and near-field scanning optical microscopy”, Appl. Phys. Lett., 60, 2484-2486(1992).) system shown schematically in FIG. 7. See also Betzig E., and Trautman J. K., “Near-field optics: Spectroscopy, and surface modification beyond the diffraction limit”, Science 257, 189-195(1992). More particularly, an exemplary system according to the invention comprises: (1) a scanning tip with a shear-force detection mechanism responsible for keeping the tip at a constant distance from the disc, (2) the Ar-ion laser, capable of generating both the blue and green light beams, (3) the optical system for the laser, (4) the mechanical system that controls the movement of the tip, (5) the light detection system and the associated optics, and (6) the data acquisition hardware and software. These components are based on well known technologies and are commercially available.

As may be desired, the Ar-ion laser, which is a gas laser, may be replaced with a blue-green diode laser. Diode lasers have significant advantages in terms of price, size and power requirements. A blue diode laser has been developed by Nichia, of Japan, which laser is based on GalnN (gallium indium nitride) semiconductor.

In a preferred embodiment, a thin layer of the crystal material is applied to a substrate and polished. The substrate may be made of a suitable material, such as a metal, including aluminum, or a plastic, including Kapton. α-Al₂O₃:C crystals can be applied to a Kapton substrate using high temperature resistant polymer films or glue. The substrate may be of any desired shape and size, such as a disk ranging in diameter from about 1 cm to about 5.25 inch. The storage media may be fixed in a drive therefor, or removable.

While the invention has been principally described in relation to the use of an α-Al₂O₃:C crystal, principles of the invention may be applied using other electron trapping phosphor-based compounds as a recording media, including, for example, MgS:Eu,Sm and SrS:Eu,Sm, wherein electrons in the phosphor-based compound are energized to a trapped state by light energy of one frequency, and the trapped electrons are returned to ground state by light energy of a different frequency, with the stored energy being released as light. The stimulation spectra for the noted phosphors is in the range of 900-1150 nm (as compared to about 400-500 for α-Al₂O₃:C).

1. An optical data storage system comprising a storage medium in which information is written and read using different light frequencies.

2. A system as set forth in claim 1, wherein the storage medium includes an electron trapping phosphor-based compound.

3. A system as set forth in claim 1, wherein the storage medium includes an α-Al₂O₃:C crystal or Cu⁺-doped fused quartz that is sensitive to light.

4. A system as set forth in claim 1, comprising a near-field scanning optical microscopy (NSOM) device for reading and/or writing to the storage medium.

5. A system as set forth in claim 4, wherein the NSOM device includes an optical probe about 30 nm from a surface of the storage medium.

6. A system as set forth in claim 4, wherein the storage medium and NSOM combine to obtain a data density of about 2500 Gb/in² or more.

7. A system as set forth in claim 1, further characterized by the use of multi-level data storage

8. An optical data storage method comprising the steps of using a light frequency of a first wavelength to write information in an optical storage medium, and using a light frequency of a different wavelength to read the written information.

9. A method as set forth in claim 8, wherein the storage medium includes an electron trapping phosphor-based compound.

10. A method as set forth in claim 8, wherein a near-field scanning optical microscopy (NSOM) device is used to read and/or write to the storage medium.

11. A method as set forth in claim 10, wherein the NSOM device includes an optical probe about 30 nm from a surface of the storage medium.

12. A method as set forth in claim 8, wherein the information is written at a data density of about 2500 Gb/in² or more.

13. A method as set forth in 8, further characterized by the use of multi-level data storage.

14. An optical data storage system comprising a storage medium including an electron trapping phosphor-based compound in which information is written and read at multiple levels using different light frequencies, and a near-field scanning optical microscopy (NSOM) device for reading and/or writing to the storage medium.

15. A system as set forth in claim 14, wherein the storage medium includes an α-Al₂O₃:C crystal or Cu⁺-doped fused quartz that is sensitive to light.

16. A system as set forth in claim 15, wherein the NSOM device includes an optical probe about 30 nm from a surface of the storage medium.

17. A system as set forth in claim 16, wherein the storage medium and NSOM combine to obtain a data density of about 2500 Gb/in2 or more.
